(19) United States
(12) Patent Application Publication
(10) Pub. No.: US 2026/0371296 A1
(43) Pub. Date: Nov. 19, 2026

(54) POSITIONING METHODS, ARCHITECTURES, APPARATUSES AND SYSTEMS WITH RECONFIGURABLE INTELLIGENT SURFACES

(71) Applicant: INTERDIGITAL PATENT HOLDINGS, INC., Wilmington (DE)

(72) Inventors: Visa TAPIO, Oulu (FI); Arman SHOJAEIFARD, London (GB); Javier LORCA HERNANDO, Madrid (ES); Pekka PIRINEN, Oulu (FI); Deepa Gurmukhdas JAGYASI, London (GB); Markku JUNTTI, Oulu (FI)

(21) Appl. No.: 19/156,242

(22) PCT Filed: Feb. 14, 2024
(86) PCT No.: PCT/US2024/015675

§ 371 Date: Aug. 13, 2025

(30) Foreign Application Priority Data
Feb. 15, 2023 (EP) 23156719.9

(51) Int. Cl. H04W 64/00; H04B 7/04; H04L 5/00

(52) U.S. Cl. CPC H04W 64/00; H04B 7/04013; H04L 5/0051

(57) ABSTRACT

In an embodiment, a method, implemented in a WTRU, comprises receiving, from a network, position of a base station, and of a first and a second reconfigurable intelligent surface units; transmitting to the first and to the second RIS units a first and a second scrambling sequence; receiving a first part of a PRS signal reflected and scrambled by the first RIS unit, a second part of the PRS signal reflected and scrambled by the second RIS unit, and a third part of the PRS signals from the base station; determining ToAs of the first, second and third part of the PRS signals; determining an association of the first and the second RIS unit with the first part and the second part of PRS signal based on the first scrambling sequence and on the second scrambling sequence; and determining the WTRU position.

### CROSS-REFERENCE TO RELATED APPLICATIONS

The present application claims the benefit of EP Patent Application No. 23156719.9 filed Feb. 15, 2023, which is incorporated herein by reference.

### FIELD OF THE INVENTION

The present disclosure is generally directed to the fields of communications, software and encoding, including, for example, to methods, architectures, apparatuses, systems directed to positioning with reconfigurable intelligent surfaces.

### BACKGROUND

Positioning may be considered as one of the key services supported by the fifth-generation new radio (5G NR) networks. The positioning in 5G NR networks may be divided in two categories, methods using 5G NR signals and methods using other resources. Techniques in the second category are network assisted global navigation satellite system positioning, observed time difference of arrival positioning based on LTE signals, enhanced cell ID methods based on LTE signals, WLAN positioning, Bluetooth positioning, terrestrial beacon system positioning and sensor-based methods (barometric pressure sensor, motion sensor). The utilization of these assumes that 5G devices will include the hardware for the listed features.

In the first category, the positioning methods with 5G NR radio resources may be any of: NR enhanced cell ID positioning, Multi-Round Trip Time (RTT) Positioning based on NR signals, Downlink Angle-of-Departure based on NR signals, Downlink Time Difference of Arrival based on NR signals, Uplink Time Difference of Arrival based on NR signals and Uplink Angle-of-Arrival based on NR signals.

In the NR enhanced cell ID positioning, the positioning may be assumed to be based on the signal quality at the wireless transmit/receive unit (WTRU). The WTRU may report the signal quality, e.g., received signal power to a base station (BS) which then determines the WTRU position. Signal quality at the WTRU may be reported to a BS as synchronization signal (SS) reference signal received power (SS-RSRP), SS reference signal received quality (SS-RSRQ), channel state information (CSI) reference signal received power (CSI-RSRP) and CSI reference signal received quality (CSI-RSRQ). However, 3GPP standard does not specify how these should be used in the positioning.

In the multi-RTT positioning, the WTRU and location management function (LMF) at the network may transfer positioning information to each other. This information may be used when the position of the WTRU is needed. The information provided by the LMF to the WTRU and by the WTRU to LMF is defined in Tables 8.10.2.1-1 and 8.10.2.2-1 in document “3GPP TS 38.305 V17.3.0 (2022 December)”.

The WTRU positioning may be performed also by estimating its direction from the BS. In the downlink, this may be done by finding the angle-of-departure and in uplink by finding the angle-of-arrival. Both these measurements may be done at the BS. In addition to the direction information, the positioning may use signal power measurements to estimate the distance between the WTRU and BS. The downlink time difference method may utilize signals transmitted from multiple BSs. In the uplink time difference method, multiple BSs may receive the signal from the WTRU. In both cases the WTRU position may be calculated by using multiple BSs.

There is a need to define a new method for performing WTRU position.

### SUMMARY

In an embodiment, a method, implemented in a wireless transmit/receive unit (WTRU) to perform positioning, may comprise: receiving, from a network, position of a base station (BS) and of a first and a second reconfigurable intelligent surface, (RIS₁, RIS₂) units; transmitting to the first and to the second RIS units respectively a first information indicating a first scrambling sequence, r₁, configuration and a second information indicating a second scrambling sequence, r₂, configuration; receiving, from the BS, a positioning reference signal, (PRS), including (1) a first PRS component reflected by the first RIS unit and comprising the first scrambling sequence, (2) a second PRS component reflected by the second RIS unit and comprising the second scrambling sequence, and (3) a third PRS component directly from the BS; and determining the WTRU position based on: (1) time of arrivals, ToAs, of the first, second and third PRS components, (2) the first and the second scrambling sequence and (3) the position of a base station, (BS), and of the first and a second RIS units.

The method may further comprise transmitting, to the base station, a first message indicating a request to start transmitting the PRS. Transmitting to the first and to the second RIS units respectively the first and the second scrambling sequence may comprise transmitting via the network. The method may further comprise transmitting, to the network, the determined WTRU position. The method may further comprise transmitting, to the BS, a second message indicating a request to stop transmitting the PRS, when WTRU positioning is determined. The method may comprise determining the ToAs of the first, second and third PRS components. The method may comprise determining an association of the first and the second RIS unit with respectively the first and the second PRS component based on the first scrambling sequence and on the second scrambling sequence.

The second scrambling sequence configuration may differ from the first scrambling sequence configuration. The first and/or the second scrambling sequence configuration may comprise a phase shift configuration of RIS elements of RIS units.

Prior to transmitting the first and the second information, the method may comprise receiving, from the network, a first and a second scrambling sequence identifiers; and selecting the first and the second scrambling sequence configuration in a codebook respectively based on the first and the second scrambling sequence identifiers.

Prior to transmitting the first and the second information, the method may further comprise selecting the first scrambling sequence, r₁, configuration and the second scrambling sequence, r₂, configuration based on other RIS units configurations.

In an embodiment, a wireless transmit/receive unit (WTRU) comprising a processor, a transceiver unit and a storage unit, may be configured to: receive, from a network, position of a base station, BS, and of a first and a second reconfigurable intelligent surface, RIS₁, RIS₂, units; transmit to the first and to the second RIS units respectively a first information indicating a first scrambling sequence, r₁, configuration and a second information indicating a second scrambling sequence, r₂, configuration; receive, from the BS, a positioning reference signal, PRS, including (1) a first PRS component reflected by the first RIS unit and comprising the first scrambling sequence, (2) a second PRS component reflected by the second RIS unit and comprising the second scrambling sequence, and (3) a third PRS component directly from the BS; and determine the WTRU position based on: (1) time of arrivals, ToAs, of the first, second and third PRS components, (2) the first and the second scrambling sequence and (3) the position of a base station, BS, and of the first and a second RIS units.

The WTRU may be further configured to transmit, to the base station, a first message indicating a request to start transmitting the PRS. Transmit to the first and to the second RIS units respectively the first and the second scrambling sequence may comprise transmit via the network. The WTRU may be configured to transmit, to the network, the determined WTRU position. The WTRU may be configured to transmit, to the BS, a second message indicating a request to stop transmitting the PRS, when WTRU positioning is determined. The WTRU may be configured to determine the ToAs of the first, second and third PRS components. The WTRU may be configured to determine an association of the first and the second RIS unit with respectively the first and the second PRS component based on the first scrambling sequence and on the second scrambling sequence.

The second scrambling sequence configuration may differ from the first scrambling sequence configuration. The first and/or the second scrambling sequence configuration may comprise a phase shift configuration of RIS elements of RIS units.

The WTRU may be configured to, prior to transmit the first and the second information, receive, from the network, a first and a second scrambling sequence identifiers; and select the first and the second scrambling sequence configuration in a codebook respectively based on the first and the second scrambling sequence identifiers.

The WTRU may be configured to, prior to transmit the first and the second information, select the first scrambling sequence, r₁, configuration and the second scrambling sequence, r₂, configuration based on other RIS units configurations.

In an embodiment, a method, implemented in a wireless transmit/receive unit (WTRU) may comprise a step of receiving, from a network node, a first message comprising configuration information, indicating a set of parameters of a set of reconfigurable intelligent surface (RIS) units including a set of RIS locations associated with a set of RIS modulation sequences. The method may further comprise a step of receiving, from a transmission/reception point (TRP), a positioning reference signal (PRS), comprising first information indicating a subset of parameters of a subset of RIS units of the set of RIS units; wherein the subset of parameters comprises subset RIS modulation sequences associated with subset RIS locations. The subset RIS modulation sequences may comprise sequences of phase shifts. The first information may further indicate TRP location such that the method may comprise a step of determining the position of the WTRU based on the time of arrivals of the reflected signals, based on the determined RIS locations of the subset of RISs associated with the reflected signals, based on the time of arrival of the PRS and based on the TRP location.

The method may further comprise a step of receiving reflected signals of the PRS signal by the subset of RIS units, wherein the reflected signals comprise the subset RIS modulation sequences. The method may further comprise a step of determining the subset RIS locations of the subset of RIS units based on the subset RIS modulation sequences of the reflected signals associated with the subset RIS locations; and a step of determining a position of the WTRU based on time of arrivals of the reflected signals and based on the determined RIS locations of the subset of RIS units associated with the reflected signals.

The method may comprise step of transmitting to the network node, a second message comprising a second information indicating the determined WTRU position and the subset of parameters. The method may comprise a step of transmitting, to the TRP, a start transmitting PRS request message.

The method may comprise a step of transmitting, to the TRP, a stop transmitting PRS message on condition that the WTRU position is determined. The method may comprise a step of determining the time of arrivals of the reflected signals. The method may comprise a step of determining the time of arrivals of the PRS.

In an embodiment, a wireless transmit/receive unit (WTRU) comprising a processor, a transceiver unit and a storage unit, may be configured to receive, from a network node, a first message comprising configuration information, wherein the configuration information indicates a set of parameters of a set of reconfigurable intelligent surface (RIS) units including a set of RIS locations associated with a set of RIS modulation sequences. The WTRU may be configured to receive, from a transmission/reception point (TRP) a positioning reference signal (PRS) comprising first information indicating a subset of parameters of a subset of RIS units of the set of RIS units; wherein the subset of parameters comprises subset RIS modulation sequences associated with subset RIS locations. The WTRU may be further configured to receive reflected signals of the PRS signal by the subset of RIS units, wherein the reflected signals comprise the subset RIS modulation sequences. The WTRU may be further configured to determine the subset RIS locations of the subset of RIS units based on the subset RIS modulation sequences of the reflected signals associated with the subset RIS locations; and to determine a position of the WTRU based on time of arrivals of the reflected signals and based on the determined RIS locations of the subset of RIS units associated with the reflected signals.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example of a system model for determining localization of a WTRU;

FIG. 3 is a flow diagram illustrating a method for determining localization of a WTRU;

FIG. 4 is a schematic view illustrating an example of phase shift variation of RIS element for scrambling sequence of beamforming;

FIG. 5 is a schematic view of an example of an impulse response detected by the WTRU;

FIG. 6 is a diagram illustrating an example of the effect of the range estimation error on the positioning accuracy of the WTRU;

FIG. 7 is a system diagram illustrating an example of a 5G NR positioning architecture extended with reconfigurable intelligent surfaces (RIS) units;

FIG. 8 is an example of a control timing diagram for positioning a WTRU;

FIG. 9 is a system diagram illustrating an example of a WTRU localization system with a reconfigurable intelligent surfaces (RIS) unit;

FIG. 10 is a block diagram illustrating an example of a base station comprising RIS units;

FIG. 11 is a flow chart diagram illustrating an example of a method, implemented in a wireless transmit/receive unit (WTRU), for WTRU positioning according to an embodiment, and

FIG. 12 is a flow chart diagram illustrating an example of a method, implemented in a wireless transmit/receive unit (WTRU), for WTRU positioning according to another embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

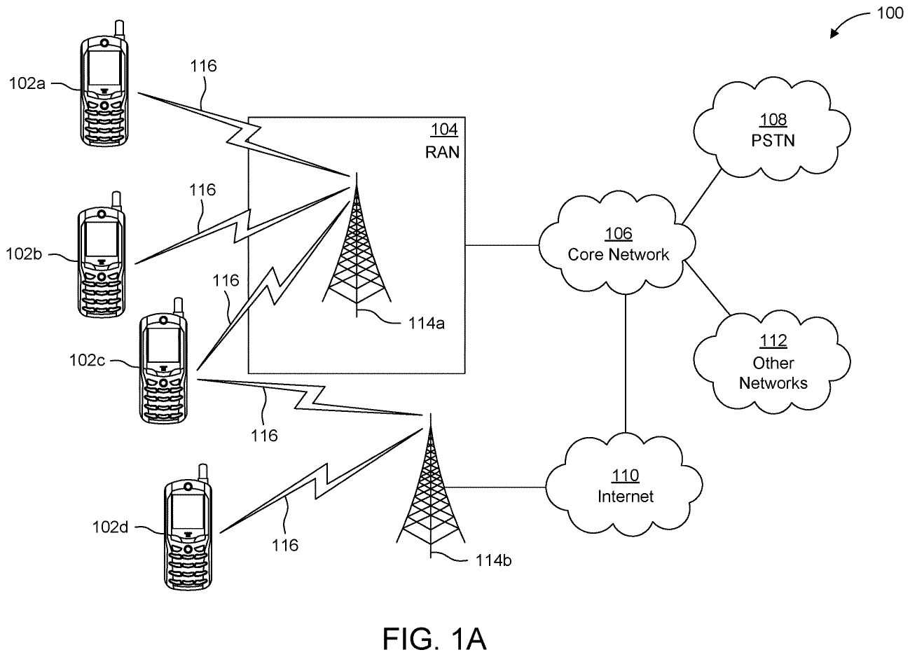

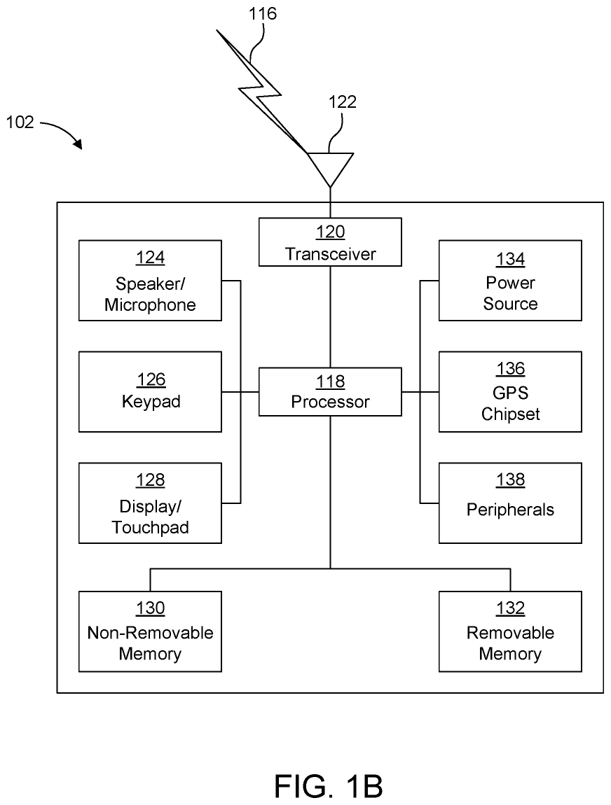

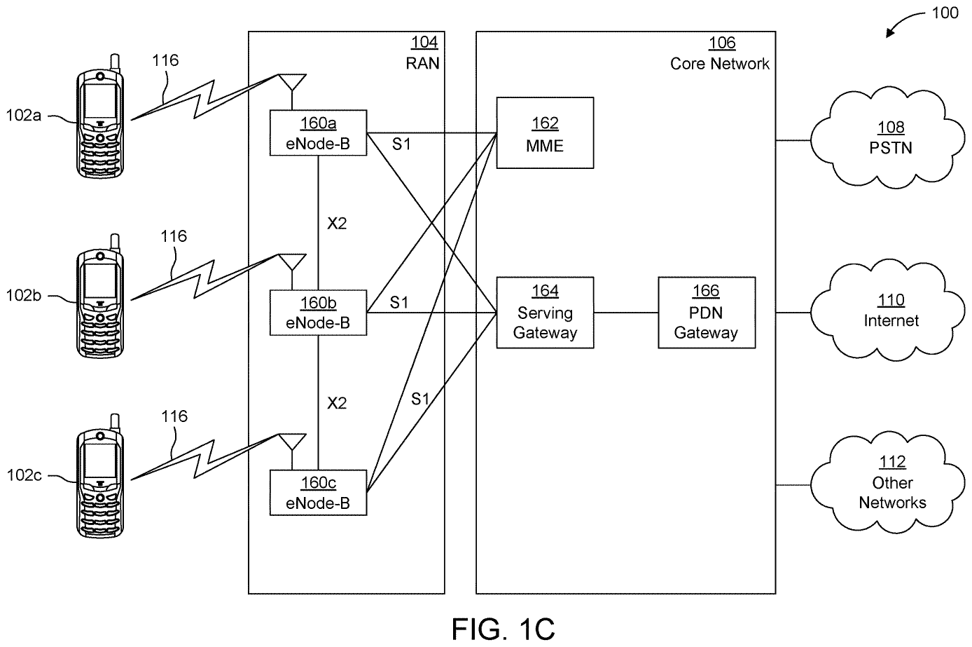

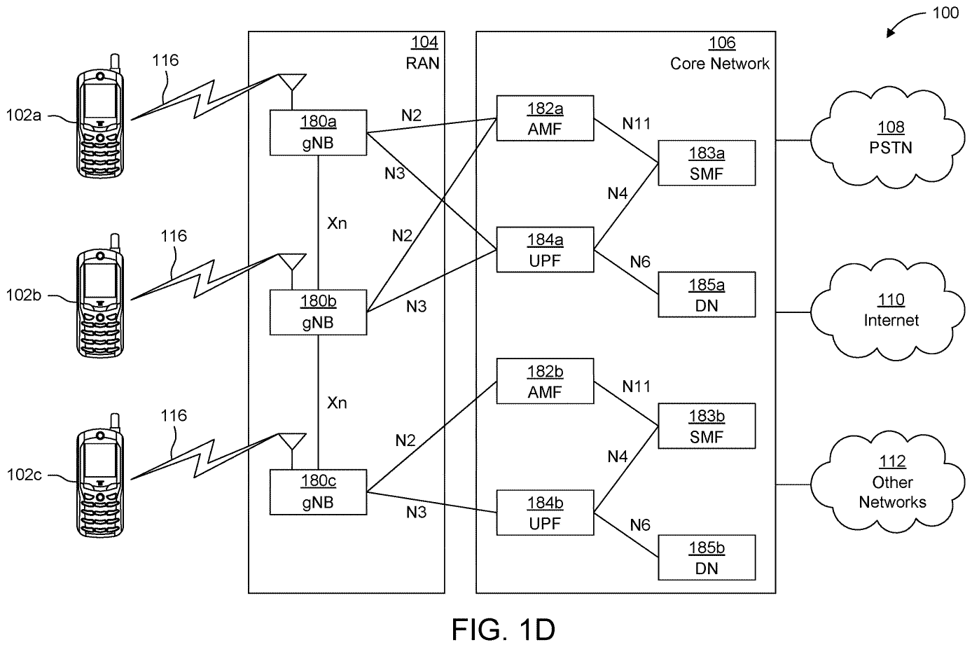

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signalling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signalling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The positioning for 5G networks may be further developed for 3GPP standard, release 18. The accuracy requirement may be expected to be below 10 cm for some applications. A method to achieve such requirement may be the usage of reconfigurable intelligent surfaces (RIS) for WTRU (e.g., mobile user equipment) positioning.

A RIS is a device that may manipulate (reflect, refract, absorb, modulate) electromagnetic waves impinging on it. They may be used in wireless systems to partially control properties of radio environments, (e.g., controlling radio channels). One of a possible application listed for RIS may be the localization of WTRUs. Since a RIS (e.g., typically) may comprise of large number of elements, it may be used to form very narrow beams and, hence, to find accurate direction of a WTRU from the RIS. The ability to form narrow beams may also be utilized for positioning. Hence, in most published works the RIS-based positioning is based on the beamforming at a RIS and delay estimation. In many cases only one RIS may be used for the positioning, but a WTRU positioning system using two RIS units may be also provided. Two RIS units may be needed since the system geometry can in some cases results in poor positioning accuracy. In an embodiment, a positioning method in may consist of two steps. In the first step, the RIS unit to be used in the positioning of the RIS is selected. In the second step, the position of the RIS is estimated based on the angle and delay measurements. Multiple RIS units may be proposed for WTRU positioning where estimated delays may be used to configure the RISs, but the delay information is not used for the actual localization. Other published RIS aided positioning solutions may utilize received signal strength or wireless fingerprints for the positioning.

The accuracy of the positioning based on finding the correct beam direction at RIS may depend (e.g., heavily) on the beam pointing accuracy. An accurate beamforming at the RIS may be a complex problem requiring the transmission of several training sequencies. In an embodiment, two RIS units may be simultaneously used for the positioning. The positioning may based on the time difference between received signal components. Hence direction information and accurate beam steering is not needed and the positioning can be performed by a single base station (BS) whereas in the (e.g., 5G NR) networks, the time difference (TD) based methods require the use of several BS for positioning.

The WTRU positioning may require that the WTRU distinguishes the signals received from different RIS units and signals reflected by other surfaces and objects.

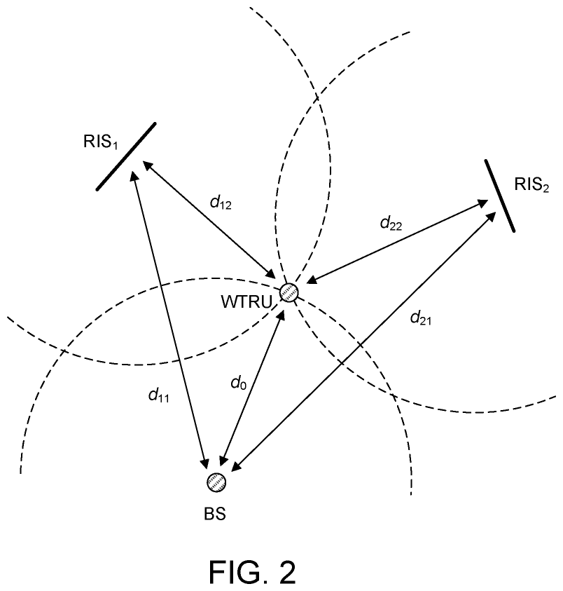

Referring to FIG. 2, a positioning system may comprise abase station (BS), a WTRU and two RIS (RIS₁, RIS₂) units. Since the BS and the two RIS units are in fixed positions, the distance from the BS to RIS₁, d₁₁, and the distance from BS to RIS₂, d₂₁ are known. The signal propagating directly from the BS to the WTRU may arrive at a time T0, wherein:

tₜₓ+d₀c⁻¹=T₀ (1)

where tₜₓ is the transmit time at the BS, c is the speed of light, and do is the distance between the WTRU and the BS.

Times-of-arrival (ToA), T₁, for path via RIS₁ unit may be expressed as:

tₜₓ+(d₁₁+d₁₂)c⁻¹=T₁ (2)

Times-of-arrival (ToA), T₂, for path via RIS₂ unit may be expressed as:

tₜₓ+(d₂₁+d₂₂)c⁻¹=T₂ (3)

Time differences between the paths in FIG. 2 may be calculated as:

T₁−T₀=(d₁₁+d₁₂)c⁻¹−d₀c⁻¹=(d₁₁+d₁₂−d₀)c⁻¹ (4)

T₂−T₀=(d₂₁+d₂₂−d₀)c⁻¹ (5)

Since the distances between the BS and RIS units may be assumed to be known, equation (4) and equation (5) form a system of equations with two equations and three unknown's distances, namely do, d₁₂ and d₂₂. T₀ solve d₁₂ and d₂₂ from equation (4) and equation (5) the direct distance d₀ may be estimated separately. This can be done with, per example, time advance calculation needed in the uplink synchronization. After unknown distances (d₀, d₁₂, d₂₂) have been solved, the WTRU position may be calculated based on the known positions of the BS and RIS units and \hat{d}₀, \hat{d}₁₂ and \hat{d}₂₂ (\hat{d}ᵢⱼ represents the estimate of dᵢⱼ). The position of the WTRU may be in the intercept point of the three doted half circles shown in FIG. 2. The unknown coordinates (x, y) of the WTRU may be calculated based on the known coordinates of the BS, RIS₁ and RIS₂ which are (x₀,y₀), (x₁,y₁) and (x₂,y₂), respectively. The WTRU position may be found by finding x and y that simultaneously fulfill the following equations (6), (7) and (8).

$${( x - {x}_{0} )}^{2} + {( y - {y}_{0} )}^{2} = {d}_{0}^{2} \qquad ( 6 )$$

$${( x - {x}_{1} )}^{2} + {( y - {y}_{1} )}^{2} = {d}_{12}^{2} \qquad ( 7 )$$

$${( x - {x}_{2} )}^{2} + {( y - {y}_{2} )}^{2} = {d}_{22}^{2} \qquad ( 8 )$$

Distances from three known positions are needed to find single-valued position. This can be seen, e.g., in FIG. 2 where each half circle pair has two distinct intercept points, but the three half circles have only one common point.

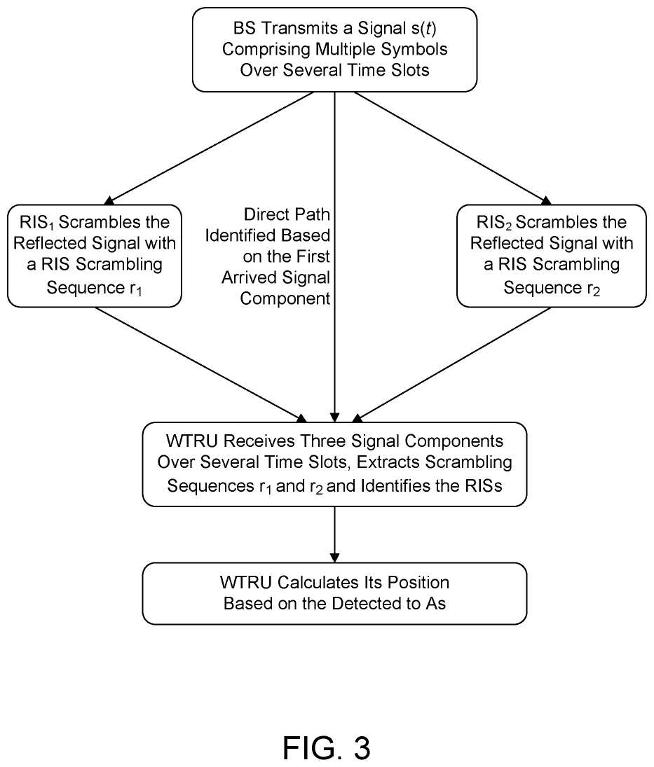

Referring to FIG. 3, in an embodiment, a process for WTRU positioning may comprise a step wherein a BS transmits a reference signal for the positioning. The signal received by the WTRU may be split into a first signal component of the reference signal, a second signal component of the reference signal and a third signal component of the reference signal. The first signal component is a first part of the reference signal, reflected by the first RIS, RIS₁, and scrambled with a first sequence r₁ by RIS₁. The second signal component is a second part of the reference signal, reflected by the second RIS, RIS₂, and scrambled with a second sequence r₂ by RIS₂. The third signal component is the third part of the reference signal from a direct path between the BS and the WTRU, wherein third signal component is the first arrived signal component at the WTRU compared to the first and second signal component. The process for WTRU positioning may comprise another step wherein the WTRU may distinguish the first and the second signal components from the third signal component based on the ToAs of the three signal components. The process for WTRU positioning may comprise another step wherein the WTRU may distinguish the first signal component from the second signal component based on the scrambling sequences (r₁, r₂) such that WTRU may identified which signal component comes from which RIS unit.

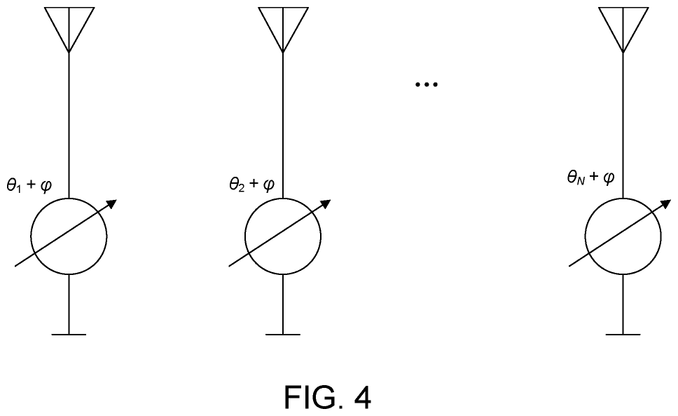

The WTRU should be able to separate the signals reflected by the RIS units from signals reflected by other objects or surfaces in the environment. This may be realized by scrambling the reflected signals at RIS units. In the context of separating signals, scrambling the reflected signals at RIS units means, for example, applying a sequence of phase shifts to all RIS elements of RIS unit on top of a RIS beamforming vector, at a rate of one phase value per time slot, such that variations of reflected signal (e.g., univocally) may identify the RIS. The time duration of the scrambling sequence may be smaller than the coherence time of the RIS to WTRU channel, as otherwise phase variations from the channel may mask those of the scrambling sequence. A scrambling sequence ID may be provided to WTRUs via higher-layer signalling (e.g., as contained in a codebook or in a WTRU controlled case). The scrambling sequence may be set by the WTRU and the WTRU may transmit to the RIS unit (e.g., RIS control unit) which scrambling sequence to use. The radiation pattern of a RIS unit depends on the phase gradient, (e.g., the phase difference between the RIS elements), and not on the absolute values of the phase responses of RIS elements. Referring to FIG. 4, this means that by varying the phase response of all elements in a RIS unit with the same value, the reflected signal is phase shifted without affecting the radiation patterns of the RIS. Referring to FIG. 3, phase shift Θ₁ . . . Θ_{N} refers to phase values used for beamforming and p is the phase shift for the scrambling.

The scrambling sequences, r₁ and r₂, of the RIS-units RIS₁ and RIS₂ may be selected to be orthogonal with each other allowing the WTRU to distinguish the signals from individual RIS unit. The scrambling of the reflected signals with orthogonal sequences also means that the resolution, e.g., the ability to distinguish the signals through the direct path and via RIS units, is not a limiting factor.

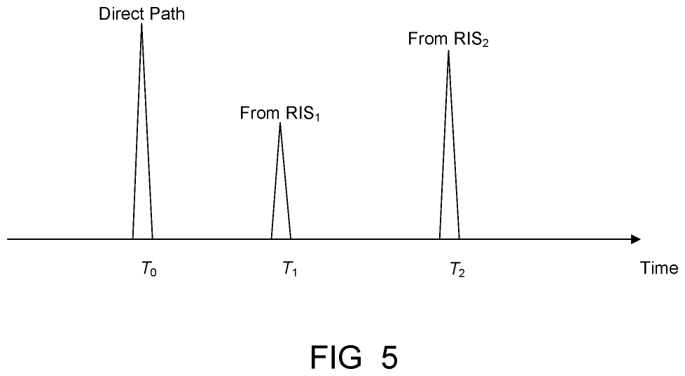

As an example, propagation paths may be identified from channel estimates. The impulse response of the estimated channel at the WTRU is illustrated in FIG. 5. The first impulse arriving at time T_0 represents the direct path and reflections from RIS units, RIS₁ and RIS₂, arrive at time instants T_1 and T_2. Since the RIS phase response is varied using a known code, the phase of the peaks at T_1 and T_2 varies accordingly. By comparing (correlating) the phase values of these peaks over multiple OFDM symbols with known sequences, reflections from RIS units may be identified.

In an embodiment, the positioning method may operate best in line-of-sight conditions where peaks in the channel impulse response are due to only reflections from RIS units and the direct path. In non-line-of-sight conditions, the performance may depend on how strong reflections arrive from other reflecting objects and on the time used for the positioning, e.g., on the length of used sequences.

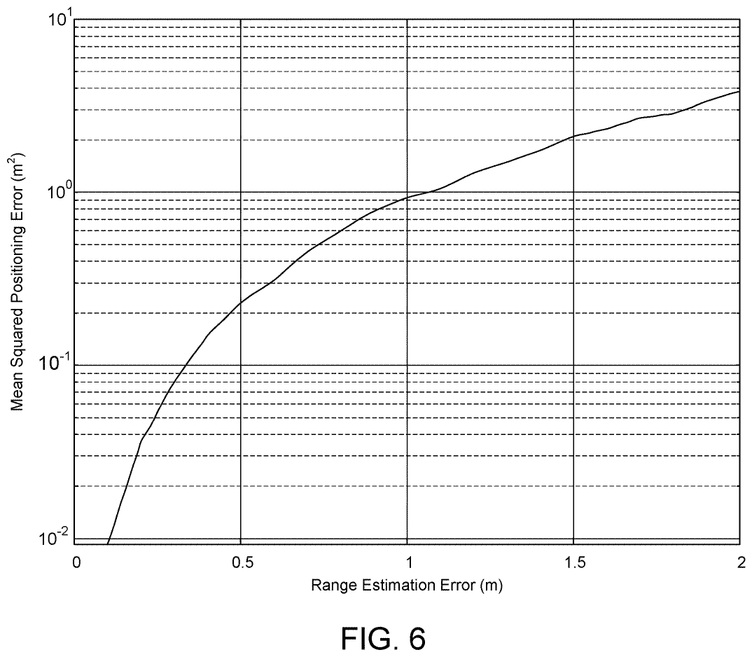

The accuracy of the positioning may depend on the accuracy of the estimates \hat{d}₀, \hat{d}₁₂ and \hat{d}₂₂. As an example, the effect of errors in \hat{d}₀, \hat{d}₁₂ and \hat{d}₂₂ is shown in FIG. 6 wherein BS, RIS₁ and RIS₂ coordinates are (0,0), (−30,45) and (30,45) and WTRU is located randomly in the area defined by x∈[−100,100] and y E [−100,100]. The range estimation error axis represents the average positioning error when the error is uniformly distributed around the correct range. E.g., the error 1 meter (m) means that dᵢⱼ−0.5 m≤\hat{d}ᵢⱼ≤dᵢⱼ+0.5 m where dᵢⱼ is the true distance. The mean squared positioning error is calculated as

$$Δ P = \frac{1}{N} ( {\vert x - \hat{x} \vert}^{2} + {\vert y - \hat{y} \vert}^{2} ) \qquad ( 9 )$$

where N is the number of randomly selected positions (N=1000 in FIG. 6).

In a 3GPP system, the WTRU position may be used to support radio resource management and location-based services for operators, users, and third-party service providers. Many of the current location-based services relay on the global positioning system (GPS) or other global navigation satellite systems (GNSS). The GPS and other GNSS systems may provide very accurate positioning information. However, the positioning with GPS takes typically (e.g., normally) at least 30 seconds and if the conditions are not ideal for the GPS signal it can take minutes for GPS receiver to search for satellites and pinpoint the WTRU location, or the positioning fails completely. According to the embodiments described herein, the time scale for the positioning process (for example, in 5G NR or beyond system) may be milli-seconds depending on the details how the integration is realized.

The use cases for the positioning considered in 3GPP systems include the positioning of users and devices (e.g., WTRUs) in general indoor environments (offices, shops, etc.), vehicle location in combination with GNSS positioning for vehicular-to-anything applications, drone and other unmanned aerial system localization, industrial internet-of-things (IoT) and massive IoT. The 3GPP positioning solutions are planned to be forward compatible with other systems such as the user plane localization of Open Mobile Alliance.

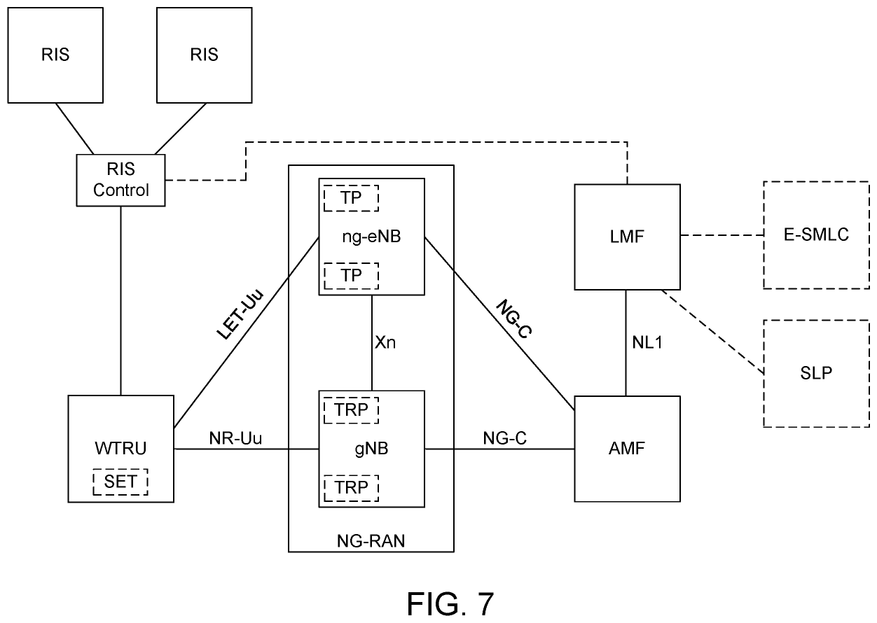

The applicability of the embodiment described herein, is not limited to any specific system or application. However, the most likely standard for the deployment of RIS is the 5G and beyond 5G networks. Hence, the integration of the positioning procedure described herein into 5G NR is considered. The positioning procedure described herein may be applicable beyond 5G networks. As a non-limited example, the RIS extended WTRU positioning architecture in 5G NR is sketched in FIG. 7. Referring to FIG. 7, the added RIS units and the RIS control unit are integrated into a 5G system architecture. The added RIS units and the RIS control unit may also be integrated in any of wireless networks.

Only two RIS units and one RIS control unit is drawn in 6, but the system may include also more RIS units, and they all can have their own control units. The WTRU may control RIS units directly. RIS control units may be controlled by the network (e.g., LMF, base station, transmission-reception point (TRP)), or the network (e.g., LMF) and the WTRU may control RIS units jointly. The connection between the RIS control unit and the network (e.g., LMF) is drawn with the dashed line indicating that it is an optional link, especially in the WTRU controlled RIS use case. More detailed treatment of the RIS integration into the 5G networks requires extensive development and changes in the standard.

When considering the application of RIS units in 5G NR networks and also in other wireless networks, especially when RIS-units are deployed as part of a network infrastructure, the effect on above listed specifications needs to be considered.

The current 5G standard does not include the use of RIS and, hence, does not describe any procedure for the RIS control. Further, the 5G standard does not have functions for a WTRU to control other network nodes. A case where a RIS is part of the network infrastructure and WTRU is controlling, it may require substantial changes to the standard. These changes may be not only limited to the physical layer but extend also to higher layers. In fact, the inclusion of a RIS as a network element into the wireless network (e.g., 5G NR or beyond 5G NR) may have a larger effect upon the higher layers than on the physical layer. Hence, the procedure for WTRU controlled RIS unit described below is illustrating some of the needed steps but may not cover the whole integration process.

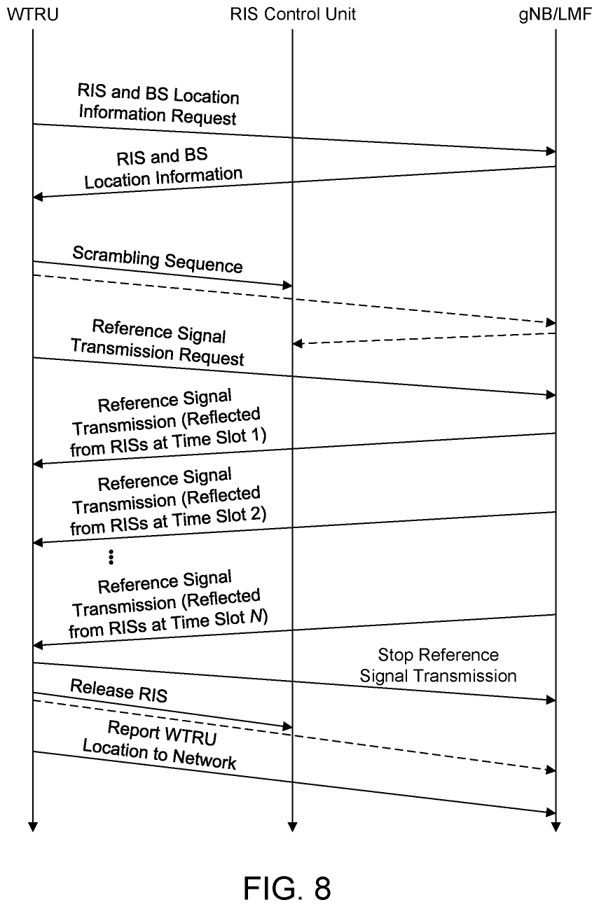

The 5G NR standard may (e.g., readily) support WTRU based positioning with the positioning reference signal (PRS). The PRS may be utilized also in the RIS assisted downlink positioning. Referring to FIG. 8, the steps for the WTRU controlled positioning process may be: (1) WTRU may request the network to provide positions of the BS (e.g., gNB) and RIS units. The positions may be absolute positions (e.g., UTM coordinates) or relative position (e.g., RIS position relative to the BS (e.g., gNB) position). Since the base station (e.g., gNB) and RIS units are static as they do not move, the positions information may be included in a control information sent by the BS to a cellular cell. Positions information may be indicated (e.g., signalled) via an index that points to a pre-defined table of BS (e.g., gNB) and RIS positions; (2) WTRU may select RIS scrambling sequences (r₁, r₂) for the RIS units for signal separation. (3) WTRU may instruct BS (e.g., gNB) to configure RIS units for positioning, e.g., to start to vary RIS configurations according to the selected RIS scrambling sequence; Alternatively, if the WTRU can directly control RIS units, it may select the used scrambling sequences for the reflections; (4) WTRU may request BS (e.g., gNB) to start transmitting the PRS. (5) WTRU may detect the ToAs of the received signals and calculates its position. (6) WTRU may inform the BS (e.g., gNB) about the end of the positioning process and to stop the reference signal transmission. (7) The WTRU may reports its position to the network.

The timing diagram for the above steps is sketched in FIG. 8 and may be applicable for 5G network and beyond 5G network. The dashed lines in the diagram represent alternative control paths where the WTRU controls a RIS through the BS (e.g., gNB)/network (e.g., LMF) while continuous lines assume that the WTRU may directly communicate with a RIS control unit.

WTRU may initiate the RIS assisted positioning similarly with the procedure described in Section 8.12.3.1.2.2 UE Initiated Assistance Data Transfer in “3GPP TS 38.305 V17.3.0 (2022 December)”. At this stage, the WTRU may send a request assistance data message to the LMF. As a response to the request, the LMF may provide the assistance data to the WTRU. The presence and position information of the RIS units may be added to the information provided by the network (e.g., LMF). In case of the WTRU discovers the opportunity to utilize the RIS resources, it may decide to utilize them in the location/positioning process.

The main change that may be added in the standard is the control of the RIS. For the positioning the RIS units may be set to vary the phase of the reflected signals, e.g., RIS units phase modulate the impinging signals. A sequence of phase shifts at separate RIS units may be orthogonal for the WTRU to identify the signals coming from an individual RIS. Orthogonality may be realized, e.g., by selecting the scrambling sequence according to orthogonal sequences, such as spreading codes used in spread spectrum systems. However, the codes may be not used to spread the signal bandwidth, but to modulate the channel impulse response. After the network (e.g., LMF) has provided locations of the serving BS (e.g., gNB) or transmission-reception point (TRP) and RIS units, the WTRU may access to the RIS control, or instruct the BS (e.g., gNB) or the network (e.g., LMF) to configure RIS units for the positioning. One possible option for the RIS set-up may be to modify the WTRU initiated on-demand PRS transmission to include the RIS configuration information to the signalling described in Section 7.6 Procedures for On-Demand PRS transmission in “3GPP TS 38.305 V17.3.0 (2022 December)”. In this option, scrambling sequences for RIS-units would be selected from a pre-defined set. However, there may be also other possible options for integrating RIS assisted positioning into 5G. E.g., a WTRU may typically (e.g., readily) use synchronization signal/physical broadcast channel block (SSB) and channel state information reference signal CSI-RS for positioning in downlink. E.g., the RIS-units may be used to modulate the channel during the SSB transmission. If all WTRUs in the serving cell know locations of the BS (e.g., gNB)/TRP and RIS-units and used RIS scrambling sequences, they may all calculate their positions with the proposed process.

The operations of a WTRU, for example, but not limited to, in 5G NR, may be (e.g., tightly) controlled by the network. This means that the inclusion of WTRU controlled RIS units in wireless network (e.g., 5G or beyond 5G) standard may be a challenging task and require many changes to the standard, e.g., the RIS should be added to overall description of the radio access network. Since the RIS units may be allocated and shared with multiple WTRUs, the physical layers current specification in current standard may be updated, as well as upper layers controlling the radio resources, scheduling, etc.

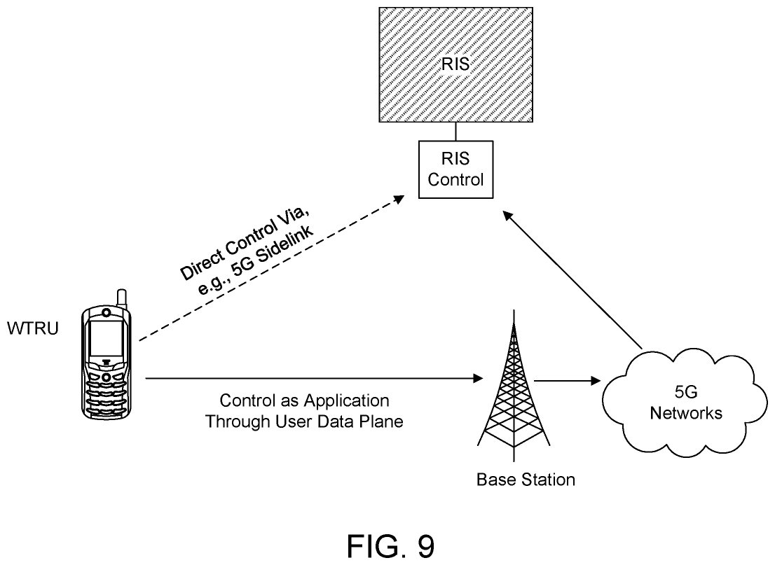

In the WTRU controlled case (e.g., WTRU communicates with RIS control units on the selection and on usage of r₁ and r₂ for RIS control), a potentially simpler method would be to connect WTRUs with RIS units through a data plane and consider RIS units as applications or services, as depicted on FIG. 9. This would also enable WTRUs to detect RIS units as a proximity-based service. In this set-up, the WTRU would use existing wireless network (e.g., 5G NR) reference signals for ToA measurements without changes on how the transmission of reference signals is handled in the wireless network (e.g., 5G). To minimize the latency in the RIS control, the control link can be established as an ultra-reliable low-latency communication (URLLC) service. As also depict on FIG. 9, another possible option is to form a sidelink between a WTRU and RIS control unit and use the user plane to control the RIS as an application.

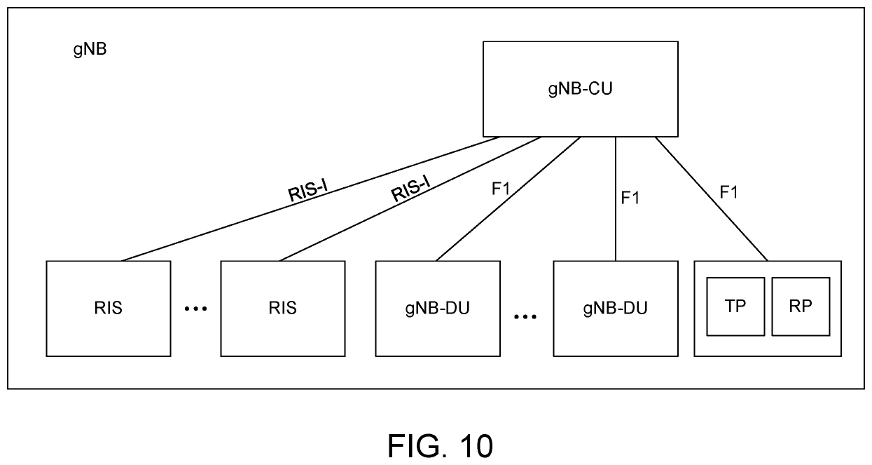

In an embodiment, a positioning procedure may be applied also in the uplink direction. The RIS based uplink positioning using a wireless network (e.g., 5G NR) signal may be based, e.g., on the use of the sounding reference signal (SRS). As an example, the required change in the 5G NR standard in this case may be the phase-shift process of the reflected signals at the RIS units. The BS may comprise an information indicating the RIS scrambling sequence (e.g., scheme) at RIS-units. One method to ensure that the BS has the information may be to integrate RIS units as parts of distributed (e.g., 5G) base station (e.g., gNB) such that the BS (e.g., gNB) may also configure RIS units for other applications, such as coverage extension. As depicted on FIG. 10, a simplified block diagram of a BS (e.g., gNB) is shown in FIG. 10. It consists of a one centralized unit (gNB-CU) and distributed units (gNB-DU) connected by a F1 interface. Distribute units (gNB-DU) may be used as transmission and reception points (TP and RP) with full (e.g., NR) protocol stack or as a TP/RP mainly capable transmitting and receiving positioning reference signals. The additional RIS units may be added as additional distributed elements to the BS (e.g., gNB). This will require a new interface (RIS-I) for the RIS control. However, the principle of the proposed positioning method may be utilized also with other set-ups and in other than 5G NR systems. RIS units integration into a 5G BS (e.g., gNB) shown at FIG. 10 is a non-limited example of integration of one or more RIS units in a base station.

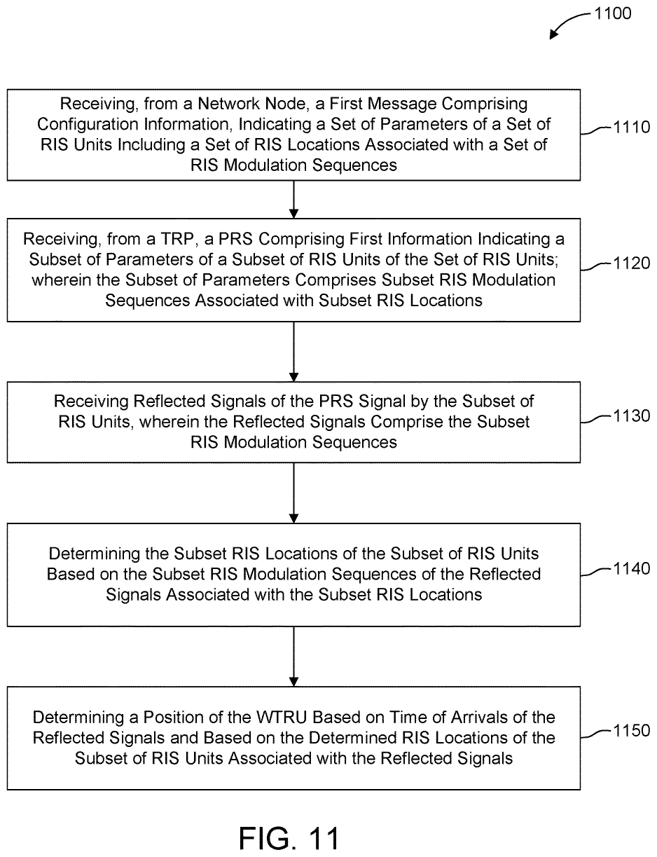

Referring to FIG. 11, in an embodiment, a method 1100, implemented in a wireless transmit/receive unit (WTRU), for WTRU positioning may comprise a step of receiving 1110, from a network node, a first message comprising configuration information, indicating a set of parameters of a set of reconfigurable intelligent surface (RIS) units including a set of RIS locations associated with a set of RIS modulation sequences. The method 1100 may further comprise a step of receiving 1120, from a transmission/reception point (TRP) a positioning reference signal (PRS) comprising first information indicating a subset of parameters of a subset of RIS units of the set of RIS units; wherein the subset of parameters comprises subset RIS modulation sequences associated with subset RIS locations. The method 1100 may further comprise a step of receiving 1130 reflected signals of the PRS signal by the subset of RIS units, wherein the reflected signals comprise the subset RIS modulation sequences. The method 1100 may further comprise a step of determining 1140 the subset RIS locations of the subset of RIS units based on the subset RIS modulation sequences of the reflected signals associated with the subset RIS locations; and a step of determining 1150 a position of the WTRU based on time of arrivals of the reflected signals and based on the determined RIS locations of the subset of RIS units associated with the reflected signals.

The subset RIS modulation sequences may comprise sequences of phase shifts. The first information may further indicate TRP location, such that the method 1100 may comprise a step of determining the position of the WTRU based on the time of arrivals of the reflected signals, based on the determined RIS locations of the subset of RISs associated with the reflected signals, based on the time of arrival of the PRS and based on the TRP location.

The method 1100 may further comprise a step of transmitting to the network node, a second message comprising a second information indicating the determined WTRU position and the subset of parameters.

The method 1100 may comprise a step of transmitting, to the TRP, a start transmitting PRS request message. The method 1100 may comprise a step of transmitting, to the TRP, a stop transmitting PRS message on condition that the WTRU position is determined. The method 1100 may further comprise a step of determining the time of arrivals of the reflected signals. The method 1100 may further comprise a step of determining the time of arrivals of the PRS.

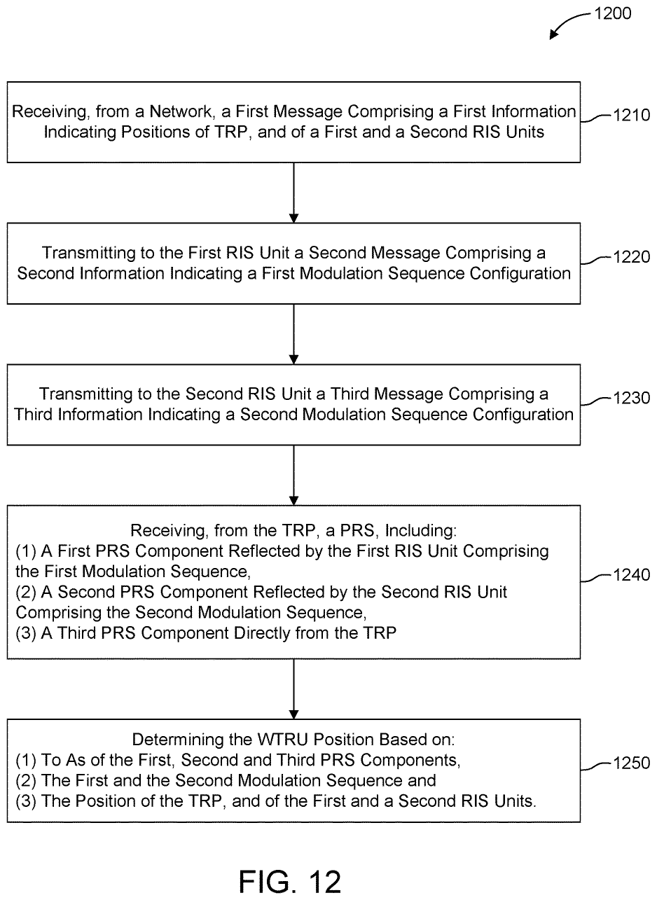

Referring to FIG. 12, in an embodiment, another method 1200, implemented in a wireless transmit/receive unit (WTRU), for WTRU positioning may comprise a step of receiving 1210, from a network, a first message comprising a first information indicating positions of transmission/reception point, TRP, and of a first and a second reconfigurable intelligent surface, RIS, units. The method 1200 may further comprise a step of transmitting 1220 to the first RIS unit a second message comprising a second information indicating a first modulation sequence configuration. The method 1200 may further comprise a step of transmitting 1230 to the second RIS unit a third message comprising a third information indicating a second modulation sequence configuration. The method 1200 may further comprise a step of receiving 1240, from the TRP, a positioning reference signal, PRS, including (1) a first PRS component reflected by the first RIS unit and comprising the first modulation sequence, (2) a second PRS component reflected by the second RIS unit and comprising the second modulation sequence, and (3) a third PRS component directly from the TRP; and a step of determining 1250 the WTRU position based on: (1) time of arrivals, ToAs, of the first, second and third PRS components, (2) the first and the second modulation sequence and (3) the position of the TRP, and of the first and a second RIS units.

The first and/or the second scrambling sequence configuration may comprise a phase shift configuration of RIS elements of RIS units.

The method 1200 may further comprise a step of comprising transmitting, to the network, a fourth message comprising a fourth information indicating the determined WTRU position. The method 1200 may further comprise a step of transmitting, to the BS, a fifth message indicating a request to stop transmitting the positioning reference signal (PRS), when WTRU positioning is determined. The method 1200 may further comprise a step of determining the ToAs of the first, second and third PRS components.

The method 1200 may further comprise, prior to the step of transmitting 1220 the second information and transmitting 1230 the third information, a step of receiving, from the network, a sixth message comprising sixth information indicating a first and a second modulation sequence identifiers; and a step of selecting the first and the second modulation sequence configuration in a codebook respectively based on the first and the second modulation sequence identifiers.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented in a wireless transmit/receive unit (WTRU) comprising:
receiving, from a network node, a first message comprising configuration information, a set of locations of a set of reconfigurable intelligent surface (RIS) units, and wherein the set of locations are associated with a set of modulation sequences;
receiving a positioning reference signal (PRS) from a transmission/reception point (TRP), wherein the PRS comprises first information indicating a subset of the set of modulation sequences associated with a subset of the set of locations;
receiving a set of signals corresponding to the PRS, wherein the set of signals are (i) reflected by the subset of RIS units, and (ii) modulated in accordance with the subset of modulation sequences;
determining a subset of locations based on the subset of modulation sequences; and
determining a position of the WTRU based on (i) a set of times of arrival of the set of signals, and (ii) the subset of locations.

2. The method of claim 1, comprising transmitting, to the network node, a second message comprising a second information indicating the position of the WTRU and the subset of locations.

3. The method of claim 1, wherein at least one of the subset of modulation sequences comprises a sequences of phase shifts.

4. The method of claim 1, comprising transmitting, to the TRP, a request to start transmitting PRS.

5. The method of claim 1, comprising transmitting, to the TRP, a request to stop transmitting PRS after the position of the WTRU is determined.

6. The method of claim 1, comprising determining the set of times of arrival of the set of signals.

7. The method of claim 1, wherein the first information further indicates a location of the TRP, and wherein the method comprises determining the position of the WTRU based on (i) the set of times of arrival, (ii) the subset of locations, (iii) a time of arrival of the PRS, and (iv) on the location of the TRP.

8. The method of claim 7, comprising determining the time of arrival of the PRS.

9. A method, implemented in a wireless transmit/receive unit (WTRU) comprising:
receiving, from a network, a first message comprising a first information indicating a first position of a transmission/reception point (TRP), a second position of a first reconfigurable intelligent surface (RIS) unit, and a third position of a second RIS unit;
transmitting, to the first RIS unit, a second message comprising a second information indicating a first modulation sequence configuration;
transmitting, to the second RIS unit, a third message comprising a third information indicating a second modulation sequence configuration;
receiving a positioning reference signal (PRS), wherein the PRS comprises:
a first signal that is modulated in accordance with the first modulation sequence configuration and that corresponds to the PRS being reflected by the first RIS unit;
a second signal that is modulated in accordance with the second modulation sequence configuration and that corresponds to the PRS being reflected by the second RIS unit; and
a third signal that is received from the TRP; and
determining a position of the WTRU based on:
first, second and third times of arrival of the first, second and third signals;
the first and second modulation sequence configurations; and
the first, second and third positions.

10. The method of claim 9, comprising transmitting, to the network, a fourth message comprising a fourth information indicating the position of the WTRU.

11. The method of claim 9, comprising transmitting, to the TRP, a fifth message indicating a request to stop transmitting the PRS after the position of the WTRU is determined.

12. The method of claim 9, comprising determining the first, second and third times of arrival.

13-14. (canceled)

15. A wireless transmit/receive unit (WTRU) comprising a processor, a transceiver unit and a storage unit, and configured to:
receive, from a network node, a first message comprising configuration information, wherein the configuration information indicates a set of locations of a set of reconfigurable intelligent surface (RIS) units, and wherein the set of locations are associated with a set of modulation sequences;
receive a positioning reference signal (PRS) from a transmission/reception point (TRP), wherein the PRS comprises first information indicating a subset of the set of modulation sequences associated with a subset of the set of the locations;
receive a set of signals corresponding to the PRS, wherein the set of signals are (i) reflected by the subset of RIS units, and (ii) modulated in accordance with the subset of modulation sequences;
determine the subset of locations based on the subset of modulation sequences; and
determine a position of the WTRU based on (i) a set of times of arrival of the set of signals, and (ii) the subset of locations.

16. The WTRU of claim 15, configured to transmit, to the network node, a second message comprising a second information indicating the position of the WTRU and the subset of locations.

17. The WTRU of claim 15, wherein at least one of the subset of modulation sequences comprises a sequence of phase shifts.

18. The WTRU of claim 15, configured to transmit, to the TRP, a request to start transmitting PRS.

19. The WTRU of claim 15, configured to transmit, to the TRP, a request to stop transmitting PRS after the position of the WTRU is determined.

20. The WTRU of claim 15, configured to determine the set of times of arrival (iv) of the set of signals.

21. The WTRU claim 15, wherein the first information indicates a location of the TRP, and wherein the WTRU is configured to determine the position of the WTRU based on (i) the set of times of arrival, (ii) the subset of locations, (iii) a time of arrival of the PRS, and (iv) the location of the TRP.

22. The WTRU of claim 21, configured to determine the time of arrival of the PRS.
